(19) United States
(12) Patent Application Publication
(10) Pub. No.: US 2005/0056355 A1
(43) Pub. Date: Mar. 17, 2005

(54) Method of lightening a run-flat device for a motor vehicle wheel, and a device obtained thereby

(76) Inventors: Gerard Tavin, Montargis (FR); Olivier Heuze, L'Isle Adam (FR); Jean-Michel Simon, Chatillon (FR)

Correspondence Address: CLARK & BRODY, 1090 VERMONT AVENUE, NW, SUITE 250, WASHINGTON, DC, 20005, US

(21) Appl. No.: 10/917,341

(22) Filed: Aug. 13, 2004

(30) Foreign Application Priority Data
Sep. 12, 2003 (FR) 0310738

(51) Int. Cl. B60C 17/04

(52) U.S. Cl. 152/158; 156/110.1; 152/520

(57) ABSTRACT

A method of lightening a run-flat device for a motor vehicle wheel, in particular having a separable flat rim, the method consisting in configuring the run-flat device in a sandwich structure comprising a rigid inner annular portion, an intermediate annular portion of flexible or elastically deformable material, and a rigid outer annular portion, in such a manner that in run-flat mode, all of the forces transmitted by the rigid outer portion are distributed over the entire circumference of the intermediate portion, thereby enabling the thickness of the intermediate portion to be reduced and enabling the run-flat device to be made lighter in weight. The invention also provides a run-flat device implementing the above method.

The invention relates to a method of lightening a run-flat device for a motor vehicle wheel, in particular for a wheel having a separable flat rim, and the invention also relates to a device implementing the method to enable the vehicle to travel a considerable distance at a relatively high speed with a tubeless tire that is partially or totally deflated.

### BACKGROUND OF THE INVENTION

Presently known run-flat devices are generally constituted by a running ring which is mounted tightly around the rim of the wheel inside the tire. The ring is made either as a relatively flexible single piece having a slice removed therefrom, or else as two rigid pieces in the form of circular arcs or sectors. In order to mount the ring tightly around the rim, it is necessary to provide assembly and tightening connection means between the two facing ends of ring sectors. The assembly and tightening connection means are constituted by mechanical elements such as screw-and-nut fasteners, for example. Unfortunately, experience shows that such rigid connection means constitute the fragile elements in such run-flat devices (e.g. due to fatigue phenomena), and numerous solutions are proposed in the prior art in order to overcome as well as possible the problem posed by such connection means.

The Applicant has much experience in the field of run-flat devices, and has been particularly addressing the problem of the weight and the stiffness of such devices, which has led to studies seeking to reduce their weight while also making it possible to adjust their stiffness.

In general, in the run-flat configuration with a conventional running ring, loads or forces are applied locally to the ring which works in compression, thus implying that the ring must be made with a sufficient quantity of material, thereby leading to a certain amount of weight, since at any one time only a small fraction of the ring is stressed.

### OBJECTS AND SUMMARY OF THE INVENTION

Consequently, an object of the invention is to devise a novel type of run-flat device that presents a lighter structure while nevertheless satisfying the required performance criteria.

To this end, the invention provides a method of lightening a run-flat device for a motor vehicle wheel, in particular having a separable flat rim, the method consisting in configuring the run-flat device in a sandwich structure comprising a rigid inner annular portion, an intermediate annular portion of flexible or elastically deformable material, and a rigid outer annular portion, in such a manner that in run-flat mode, all of the forces transmitted by the rigid outer portion are distributed over the entire circumference of the intermediate portion, thereby enabling the thickness of the intermediate portion to be reduced and enabling the run-flat device to be made lighter in weight, with all of the material of the intermediate portion being stressed continuously.

The method of the invention also consists in providing a rigid inner annular portion that is hollow, and in blocking the two beads of the tire against the two flanges of the rim by means of two annular bead locks secured to the rigid inner portion of the run-flat device.

In general, the method may consist in making the run-flat device in the form of a one-piece ring, and in splitting said ring into at least two portions so as to be able to mount it on the rim, prior to assembling the two portions to each other.

The invention also provides a run-flat device for a motor vehicle wheel, in particular a wheel having a separable flat rim, the device being for mounting on the rim inside a tubeless tire, the device comprising at least three concentric and coaxial portions forming a sandwich type structure comprising a rigid inner annular portion, an intermediate annular portion of a flexible or elastically deformable material, and a rigid outer annular portion.

In general, an annular space is left between the rim and the flexible intermediate portion of the run-flat device, and the flexible intermediate portion is continuous or discontinuous.

In an embodiment of the invention, the rigid inner portion of the run-flat device includes two annular bead locks for blocking the two beads of the tire in position respectively against the two flanges of the rim, and the rigid inner portion of the run-flat device further includes at least two annular side plates, and the flexible intermediate portion is fixed to the peripheries of the two side plates on the inside or outside thereof.

In an embodiment of the invention, the outer rigid portion is of T-shaped right half-section with a web constituted by an annulus having two flanges at its periphery which form the run-flat running surface, the radially-inner portion of the annulus being secured to the flexible intermediate portion.

By way of example, the outer rigid portion may be constituted by an annular box beam with straight or sloping side walls, and the flexible intermediate portion of elastomer material may be reinforced by metal reinforcing elements, which elements may be constituted by plates that extend substantially parallel to the side plates of the rigid inner portion, it being understood that the flexible intermediate portion may also be constituted by studs in the form of metal springs.

In general, the three elements making up the run-flat device may be of different geometrical shapes, some of which are described explicitly below, it being understood that these shapes can contribute to giving the device, in its run-flat configuration, greater ability to withstand the loads due to axial stresses, for example while the vehicle is cornering.

A run-flat device of the invention does not generate any vibration in normal running mode, regardless of the pressure to which the tire is inflated. Furthermore, the clamping action of the run-flat device on the beads of the tire can serve in particular to prevent any possibility of debeading, and can assist in providing drive.

The invention is particularly applicable to military vehicles, and it enables the weight of a run-flat device to be reduced from about 20 kilograms (kg) to only 10 kg to 12 kg, which represents a weight reduction of nearly 50%. Given that a military vehicle may have four, eight, or even 16 wheels, this reduction in weight is considerable, and amply demonstrates the advantage of the invention.

### BRIEF DESCRIPTION OF THE DRAWINGS

Other advantages, characteristics, and details of the invention appear from the following description made with reference to the accompanying drawings given purely by way of example and in which:

FIG. 1 is a half-view in axial section of a first embodiment of a run-flat device in accordance with the invention;

FIGS. 2 to 9 are likewise half-views in axial section for showing other embodiments of a run-flat device in accordance with the invention;

FIG. 10 is a half-view in axial section of a particular embodiment of the invention; and

FIG. 11 is a theoretical diagrammatic view for showing the technique whereby the FIG. 10 run-flat device is mounted inside a tire.

### MORE DETAILED DESCRIPTION

In conventional manner, a run-flat device is housed inside a tubeless tire P and is mounted on the rim 3 of a motor vehicle wheel fitted with the tire P.

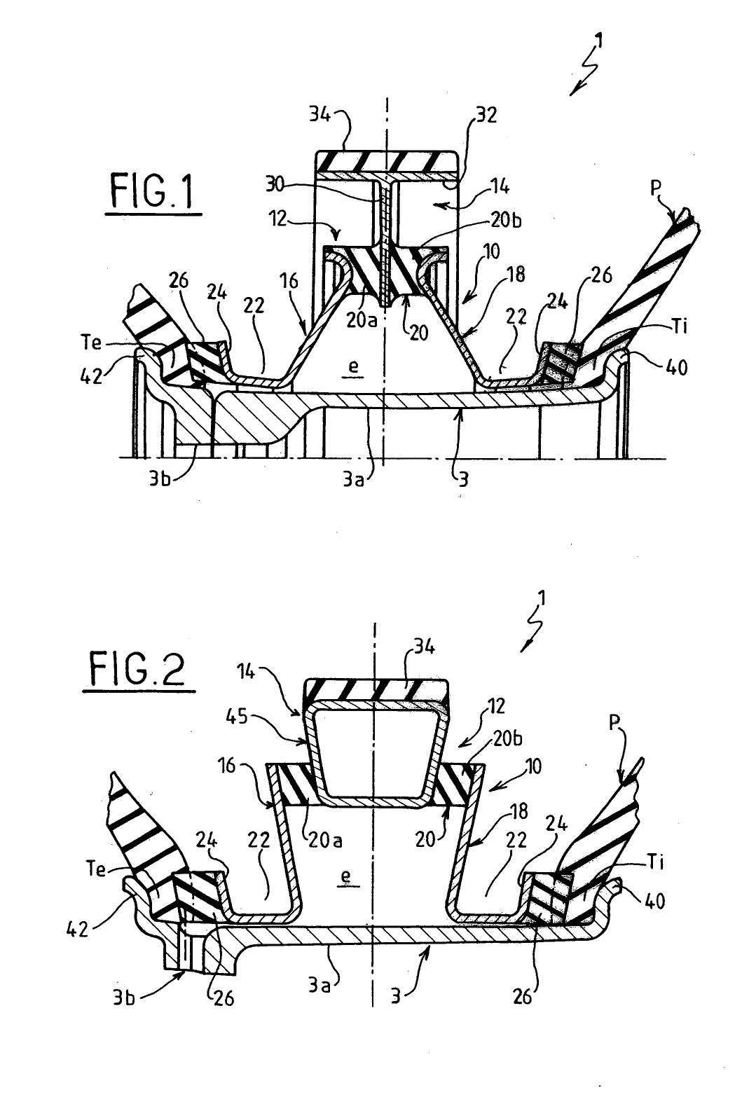

The basic structure of a run-flat device 1 of the invention as shown in FIG. 1 comprises at least three concentric and coaxial portions forming a sandwich type structure with a rigid inner annular portion 10, an intermediate annular portion 12 of material that is flexible or elastically deformable, and a rigid outer annular portion 14. In general, the rigid inner portion 10 is hollow and comprises at least two rigid annular side plates 16 and 18 which may be made of metal or of a reinforced plastics material; the flexible intermediate portion 12 is in the form of a continuous or discontinuous ring 20, e.g. of rubber, which is fixed between and at the periphery of the two side plates 16 and 18; and the rigid outer portion 14 is fixed to the flexible ring 20, and at its periphery it forms the run-flat running surface on which the tread of the tire P can come to bear in the run-flat configuration.

The run-flat device 1 of the invention is specifically designed for a separable flat rim comprising at least two portions, i.e. a rim that does not present a drop center, and that does not define a well between the two flanges of the rim and two peripheral humps for receiving the inner and outer beads of the tire.

Various embodiments of the run-flat device 1 of the invention are described below.

In a first embodiment as shown in FIG. 1, the two side plates 16 and 18 define, in right half-section, a frustoconical shape that flares towards the rim 3. The radially-inner portion of each side plate 16 and 18 of the rigid inner portion 10 presents a peripheral groove 22 of channel-shaped right section defined by an outer flange 24. The bottom of the groove 22 defines the inside diameter of the run-flat device 1 and also serves as a surface that makes contact with the rim 3 when the tire P is running in run-flat mode. Furthermore, an annular bead lock 26 of elastically deformable material such as rubber is fixed on the outer peripheral surface of each flange 24 of the side plates 16 and 18 so as to lock the beds Ti and Te of the tire P in position against the flanges of the rim.

The ring 20 of the flexible intermediate portion 12 is fixed to the peripheries of and between the two side plates 16 and 18, it being understood that this ring 20 may be discontinuous, e.g. being in the form of studs of elastomer material that are regularly spaced apart angularly.

The rigid outer portion 14 has a right half-section that is T-shaped with a central web constituted by an annulus 30 having two flanges 32 at the periphery of the annulus 30 to form the run-flat running surface, which is advantageously coated with a flexible coating 34. The radially-inner portion of the annulus 30 is secured to the flexible intermediate portion 12. More precisely, the flexible intermediate ring 20 is built up from two series of studs 20a and 20b which are separated by the annulus 30 and which are secured by screws or adhesive, for example.

In general, the run-flat device can be made by molding so as to form a one-piece ring whose inside diameter is slightly greater than the diameter of the rim 3, which ring is subsequently cut in a diametral plane containing the axis of the side plates 16 and 18 so as to form two half-rings for rim-mounting purposes. The run-flat device 1 is mounted on the separable flat rim 3 which presents two portions 3a and 3b in the example shown in FIG. 1. The portion 3a of the rim 3 is a portion of a cylinder having, at one end, a peripheral flange or rim flange 40. The portion 3b of the rim 3 is generally formed by a side plate presenting a peripheral flange or rim flange 42.

During assembly, the tire P is partially mounted by passing only its inner bead Ti over the portion 3a of the rim 3, after which the two half-rings of the run-flat device 1 are mounted in succession inside the tire P on the portion 3a of the rim 3, and the two half-rings are assembled together to form a one-piece ring which is slid over the rim 3 towards the inner bead Ti of the tire P so that the bead lock 26 of the side plate 18 comes into contact with the inner bead Ti of the tire, thereby bringing it substantially into contact with the rim flange 40; the outer bead Te of the tire P is positioned close to the bead lock 26 of the side plate 16; the rim 3 is closed by assembling together the rim portions 3b and 3a so as to pinch the outer bead Te between the rim flange 42 and the bead lock 26; and then the tire P is put under pressure.

The two half-rings of the run-flat device 1 can be assembled together by any suitable device such as at least two connection plates held by screws, for example, or by any other technically equivalent device.

Once the run-flat device 1 has been mounted inside the tire P, an empty annular space e is defined between the side plates 16 and 18, the ring 20, and the rim 3, this space e enabling the material of the ring 20 to work freely in shear when running flat.

The second embodiment shown in FIG. 2 differs from that shown in FIG. 1 essentially by the shape of the side plates 16 and 18, and the structure of the rigid outer portion 14. More precisely, in right half-section, the two side plates 16 and 18 define a frustoconical shape which flares outwards away from the rim 3, and the rigid outer portion 14 of the run-flat device 1 is constituted by an annular box beam 45 of right half-section that is likewise trapezoidal in shape, its large base forming the run-flat running surface. The flexible intermediate ring 20 is made up of two series of studs 20a and 20b fixed respectively between the side walls of the box beam 45 and the two side plates 16 and 18.

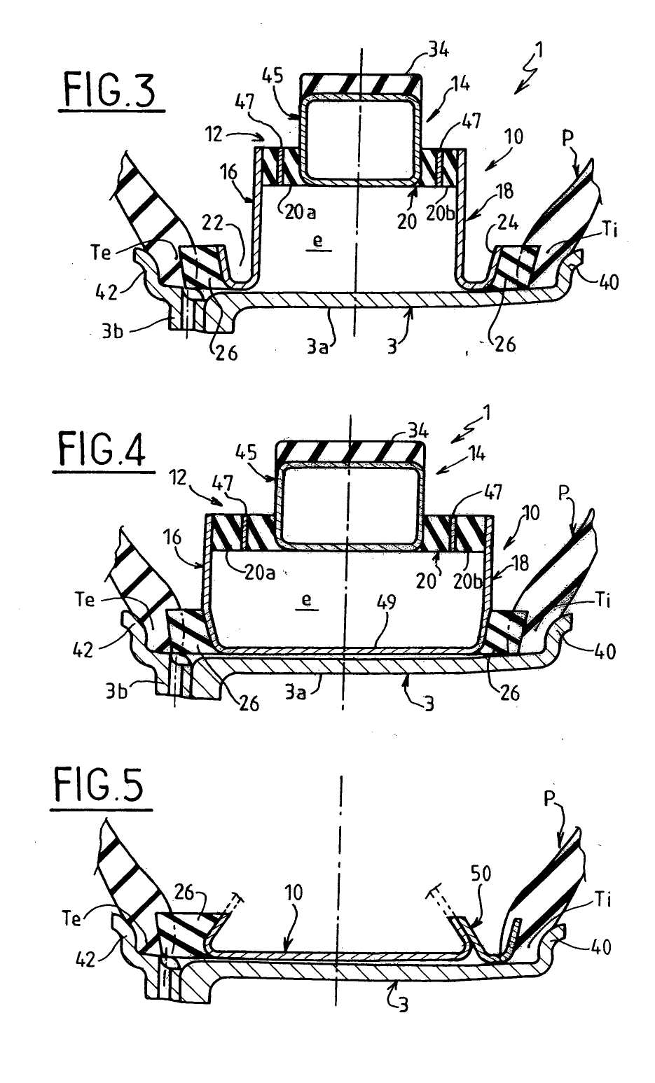

The third embodiment shown in FIG. 3 is a variant of the second embodiment. The side plates 16 and 18 are substantially parallel, the annular box beam 45 which forms the rigid outer portion 14 is of right half-section that is rectangular in shape instead of being trapezoidal, and the flexible intermediate ring 12 of the run-flat device 1 is made up of two series of studs 20a and 20b together with metal reinforcing elements that make it possible to achieve the same flexibility while increasing stiffness in horizontal compression. This stiffness makes it possible in particular to act on the extent to which the beads Ti and Te of the tire are compressed against the flanges of the rim. The metal reinforcing elements may be constituted, for example, by metal washers 47 embedded in the rubber and situated in respective planes substantially parallel to the side plates 16 and 18.

In the run-flat configuration of the tire, and for all of the above-described embodiments, the bottoms of the grooves 22 in the rigid inner portion 10 of the run-flat device 1 come locally into contact with the rim 3, this contact area nevertheless being sufficient to avoid damaging the wheel.

The fourth embodiment shown in FIG. 4 is a variant of the third embodiment in which the two side plates 16 and 18 of the rigid inner portion 10 no longer present flanges 24 defining the grooves 22. The side plates 16 and 18 are substantially plane and their radially-inner ends are united with each other by a discontinuous cylindrical bottom which surrounds the rim 3 with a small amount of clearance, this bottom being continuous or being constituted by rods 49, for example.

The fifth embodiment shown in FIG. 5 shows essentially the rigid inner portion 10 of the run-flat device in which the inner bead Ti of the tire P can be held in position by an attachment ring 50 formed as a single piece and having a right half-section that is V-shaped, for example. The two limbs of this attachment portion 50 come into rubbing contact respectively with the side plate 18 and with the inner bead Ti of the tire P.

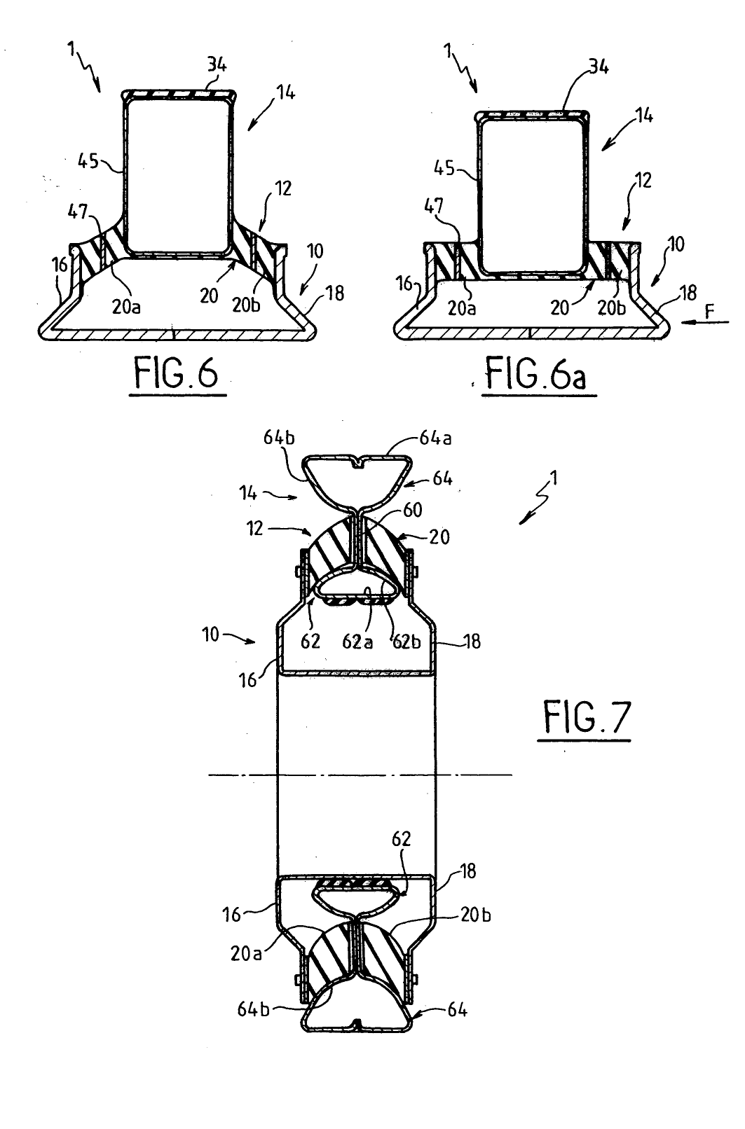

In the sixth embodiment shown in FIGS. 6 and 6a, it is desired to provide a run-flat device 1 that is better at withstanding axial stresses in the run-flat configuration. For this purpose, the rigid outer portion 14 is constituted by an annular box beam 45 of right half-section that is generally rectangular in shape, and the flexible intermediate portion 12 is disposed in inclined manner by giving it a right half-section of frustoconical shape with its large base situated beside the rim 3. Thus, in the run-flat configuration (FIG. 6a), the frustoconical shape of the flexible intermediate portion 12 deforms so as to take up a generally cylindrical shape, thereby giving the run-flat device greater ability to withstand axial stress as represented by arrow F.

The seventh embodiment shown in FIG. 7 is a variant of the invention shown in FIGS. 6 and 6a likewise for conferring greater ability to the run-flat device 1 to withstand axial stresses while in the run-flat configuration. The rigid outer annular portion 14 is generally of hourglass-shaped right half-section comprising a central web constituted by an annulus 60 which is extended by two hollow annular portions, an inner portion 62 and an outer portion 64. The inner hollow portion 62 presents a cylindrical peripheral surface 62a and two curved side surfaces 62b forming circular arcs. In similar manner, the outer hollow portion 64 presents a cylindrical peripheral surface 64a which may advantageously be covered with a flexible covering, and two curved side surfaces 64b forming circular arcs. The annular intermediate portion 12 is of frustoconical shape in right half-section, with its large base substantially in contact with the curved side surfaces 62b of the hollow inner portion 62, as can be seen in the top half-view of FIG. 7. In contrast, when in the run-flat configuration as shown in the bottom half-view of FIG. 7, the hollow inner portion 62 forms an abutment which penetrates into the space e of the rigid inner portion 10 of the run-flat device so as to come locally into contact with the rim 3, and the annular intermediate portion 12 is deformed so as to take up a frustoconical shape in right half-section that is the other way up to the shape of the top half-view of FIG. 7, i.e. it comes substantially into contact with the curved side surfaces 64b of the outer hollow portion 64 of the rigid outer annular portion 14.

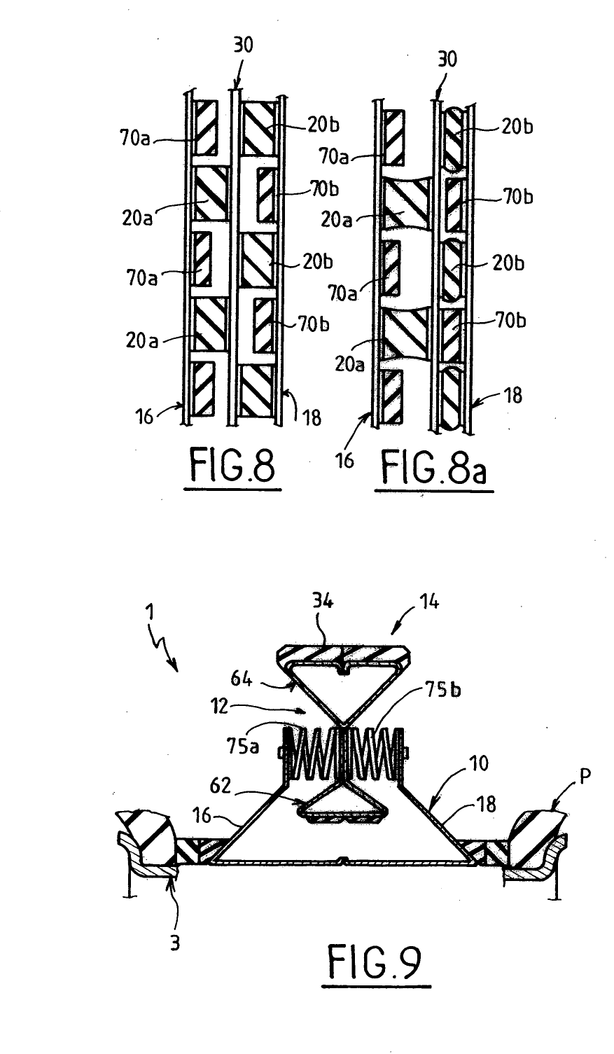

FIGS. 8 and 8a show an embodiment of the flexible intermediate portion 12 in developed form, likewise for the purpose of obtaining better response under axial stress. Returning by way of example to the embodiment shown in FIG. 1, abutments 70a are interposed between the studs 20a, and abutments 70b are disposed between the studs 20b of the flexible intermediate portion 12 so that each stud 20a secured to the side plates 16 is in register with an abutment 70b secured to the side plate 18, and each stud 20b secured to the side plate 18 is in register with an abutment 70a secured to the side plate 16. The abutments 70a and 70b are situated at a distance from the central annulus 30 and are designed to come into contact with said annulus 30 for the purpose of limiting the sideways travel of the run-flat device, as shown in FIG. 8a, where the abutments 70 can provide a progressive effect by varying their thickness or their height so that the abutments 70a and 70b never come simultaneously into contact with the annulus 30.

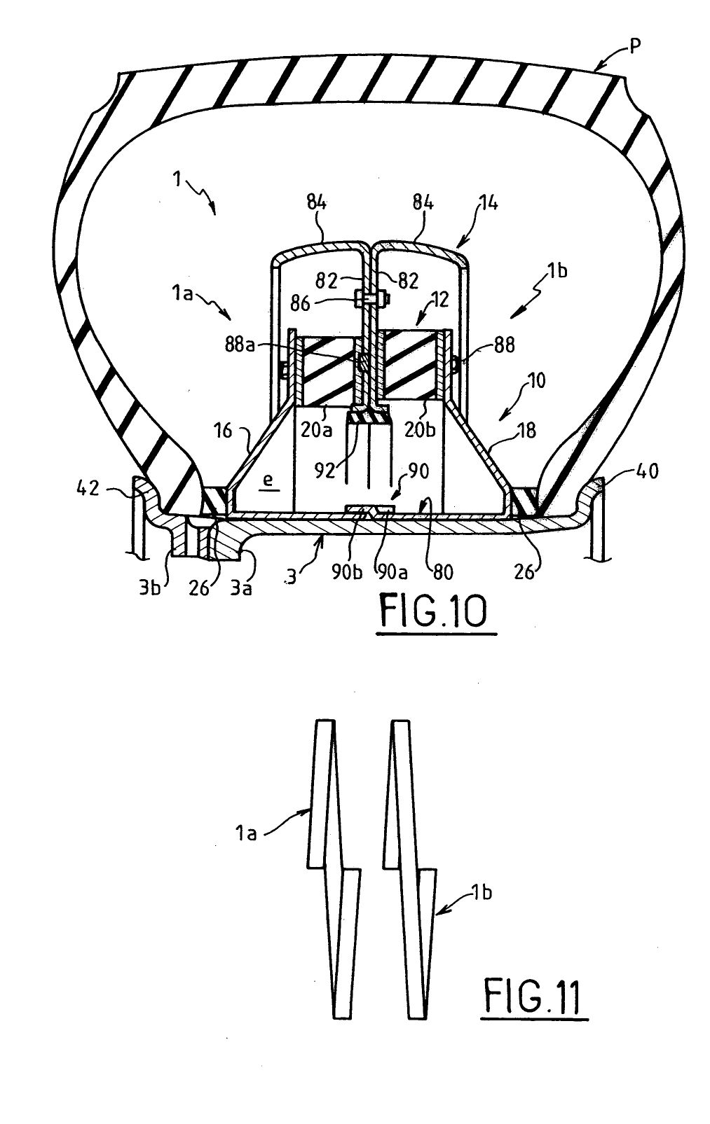

In all of the embodiments described above, the flexible intermediate portion 12 of the run-flat device is constituted by a ring or by studs of flexible elastomer material such as rubber, for example, which is suitable for working in shear in the run-flat configuration. However, in the last embodiment shown in FIG. 9, which constitutes the variant embodiment shown in FIG. 7, the flexible intermediate portion 12 is elastically deformable and is constituted solely by flexible metal elements 75a and 75b in the form of spring studs, for example.

With reference to FIG. 10, there follows a description of an embodiment of the invention which has been subjected to testing and which has given full satisfaction. The run-flat device 1 is constituted by two similar split portions 1a and 1b that are mounted head to tail. The radially-inner ends of the two side plates 16 and 18 which form the rigid inner annular portion 10 of the run-flat device 1 form a cylindrical peripheral surface 80 of diameter that is slightly greater than that of the rim 3. The radially-inner ends of the two side plates 16 and 18 face each other so as to receive the flexible intermediate portion 12 of the run-flat device 1. The radially inner and outer ends of the two side plates 16 and 18 are interconnected by two side walls that slope so that the inner annular portion 10 defines an annular space e presenting a right half-section that is frustoconical in shape, flaring towards the rim 3.

The rigid outer annular portion 14 is made up of two annuluses 82 each having its peripheral edge extended on one side only by a respective flange 84, the flanges together defining the running surface of the tire in the run-flat configuration. The two annuluses 82 disposed side by side they are fastened together by bolts 86, for example. The flexible intermediate annular portion 12 is constituted by two series of studs 20a and 20b that are angularly spaced apart from one another, being mounted between the radially-outer ends of the two side plates 16 and 18 of the rigid inner annular portion 10, and the radially-inner portions of the two annuluses 82 of the rigid outer annular portion 14. The studs 20a and 20b are secured by screws 88, it being understood that the angular offset between the two series of studs 20a and 20b enable screws 88 to pass through holes 88a formed through the touching annuluses 82.

The two portions of the side plates 16 and 18 that form the peripheral surface 80 of the rigid inner annular portion 10 are connected to each other by a staple device 90 so as to constrain them to rotate together. The staple device 90 may be constituted by two series of fingers 90a and 90b which are interleaved between one another.

Two annular bead locks 26 are stuck to opposite sides of the two side plates 16 and 18 to lock the heels Ti and Te of the tire P in position against the rim flanges 40 and 42.

Advantageously, a shoe 92 forming a damping abutment is fixed between the radially-inner ends of the two annuluses 82. This shoe 92 is designed to come into contact with the rim 3 in the run-flat configuration of the tire P. Such a shoe 92 may also be provided in the other embodiments.

The technique for mounting the above-described run-flat device is as follows. The two portions 1a and 1b are preassembled separately, the two portions 1a and 1b are inserted inside the tire P after being deformed by being twisted as shown diagrammatically in FIG. 11, the two portions 1a and 1b are assembled together in a head-to-tail configuration, the two assembled-together portions 1a and 1b are positioned on the main half-rim 3a of the wheel, and then the secondary half-rim 3b of the wheel is secured in order to clamp the assembly together.

1. A method of lightening a run-flat device for a motor vehicle wheel, in particular having a separable flat rim, the method consisting in configuring the run-flat device in a sandwich structure comprising a rigid inner annular portion, an intermediate annular portion of flexible or elastically deformable material, and a rigid outer annular portion, in such a manner that in run-flat mode, all of the forces transmitted by the rigid outer portion are distributed over the entire circumference of the intermediate portion, thereby enabling the thickness of the intermediate portion to be reduced and enabling the run-flat device to be made lighter in weight.

2. A method according to claim 1, consisting in providing an annular space between the flexible intermediate portion and the peripheral surface of the rim.

3. A method according to claim 1, consisting in locking the two beads of the tire against the two rim flanges by means of two annular bead locks secured to the rigid inner portion of the run-flat device.

4. A method according to claim 1, consisting in mounting the run-flat device on the rim with a small amount of clearance.

5. A method according to claim 1, consisting in making the intermediate annular portion in the form of a discontinuous ring of studs made of an elastomer material or as studs in the form of metal springs.

6. A method according to claim 1, consisting in making the run-flat device as two similar portions which are split, in preassembling each of the two portions, in introducing the two portions inside the tire by deforming them in twisting, in assembling the two portions together head-to-tail inside the tire, and in positioning the entire wheel rim.

7. A run-flat device for a motor vehicle wheel, in particular a wheel having a separable flat rim, the device being for mounting on the rim inside a tubeless tire, the device comprising at least three concentric and coaxial portions forming a sandwich type structure comprising a rigid inner annular portion, an intermediate annular portion of a flexible or elastically deformable material, and a rigid outer annular portion.

8. A device according to claim 7, wherein the material of the flexible intermediate portion works in shear when the tire is in the run-flat configuration.

9. A device according to claim 7, wherein an annular space is provided between the rim and the flexible intermediate portion of the run-flat device.

10. A device according to claim 7, wherein the flexible intermediate portion is substantially continuous or discontinuous.

11. A device according to claim 7, wherein the inside diameter of the run-flat device is slightly greater than the outside diameter of the rim.

12. A device according to claim 7, wherein the rim presents two rim flanges, and wherein the rigid inner portion of the run-flat device includes two annular bead locks of an elastically deformable material for locking the two beads of the tire in position against the two rim flanges, respectively.

13. A device according to claim 12, wherein the rigid inner portion of the run-flat device comprises at least two annular side plates, and wherein the flexible intermediate portion is secured to the peripheries of the two side plates and to the inside or the outside thereof.

14. A device according to claim 7, wherein the flexible intermediate annular portion of the run-flat device is constituted by two series of studs of flexible material.

15. A device according to claim 14, wherein the two series of studs are constituted by metal spring blades.

16. A device according to claim 14, wherein the two series of studs are angularly offset relative to each other.

17. A device according to claim 13, wherein the radially-inner portion of each side plate of the rigid inner portion of the run-flat device presents a U-shaped peripheral groove which is defined together with an outer flange.

18. A device according to claim 17, wherein an annular bead lock is fixed to the outer peripheral surface of each flange of the side plates.

19. A device according to claim 7, wherein the radially-inner ends of the two side plates of the rigid inner portion are united to each other by means of a discontinuous cylindrical bottom surrounding the rim with a small amount of clearance.

20. A device according to claim 7, wherein the outer rigid portion has a T-shaped right half-section with a web constituted by an annulus and with flanges at its periphery that form the run-flat running surface, the radially-inner portion of the annulus being secured to the flexible intermediate portion.

21. A device according to claim 20, wherein the outer rigid portion is constituted by an annular box beam having side walls that are straight or sloping.

22. A device according to claim 7, wherein the flexible intermediate portion is reinforced by metal reinforcing elements.

23. A device according to claim 22, wherein the metal reinforcing elements are constituted by plates that extend substantially parallel to the side plates of the rigid inner portion.

24. A device according to claim 7, wherein the flexible intermediate portion is made of a flexible material and is inclined in such a manner as to give it a right half-section of frustoconical shape for improved ability to withstand axial stresses in the run-flat configuration.

25. A device according to claim 7, wherein the outer annular portion of the run-flat device is hourglass-shaped in right half-section.

26. A device according to claim 25, wherein the outer annular portion presents a central annulus which is extended by two hollow portions, an inner hollow portion and a outer hollow portion.

27. A device according to claim 26, wherein the inner hollow portion forms an abutment suitable for coming locally to bear against the rim in the run-flat configuration.

28. A device according to claim 7, wherein the device is made of two similar split portions, the rigid inner annular portion made of two side plates presenting a cylindrical peripheral surface of diameter slightly greater than the diameter of the rim, the flexible intermediate portion being constituted by two series of studs angularly spaced apart from one another, and the rigid outer annular portion being constituted by two annuluses touching each other and having peripheral edges extended on one side only by two flanges defining the running surface of the tire in the run-flat configuration.

29. A device according to claim 28, wherein the two side plate portions of the rigid inner annular portion forming the cylindrical peripheral surface are assembled together by a staple device.

30. A device according to claim 29, wherein the staple device is constituted by two series of fingers interleaved between one another.
